(19) United States
(12) Patent Application Publication
(10) Pub. No.: US 2025/0285220 A1
(43) Pub. Date: Sep. 11, 2025

(54) ELECTRONIC DEVICE FOR RESTORING LOW-RESOLUTION IMAGE BY USING IMAGE RESTORATION MODEL TRAINED BY USING FEATURE INFORMATION OF HIGH-RESOLUTION IMAGE AND METHOD THEREOF

(71) Applicant: THINKWARE CORPORATION, Seongnam-si (KR)

(72) Inventor: Dongwoo PARK, Seongnam-si (KR)

(21) Appl. No.: 19/069,281

(22) Filed: Mar. 4, 2025

(30) Foreign Application Priority Data
Mar. 5, 2024 (KR) 10-2024-0031653

(51) Int. Cl. G06T 3/4046; G06V 20/62; G06V 30/18; G06V 30/19

(52) U.S. Cl. CPC G06T 3/4046; G06V 20/625; G06V 30/18; G06V 30/19147

(57) ABSTRACT

According to an embodiment, an electronic device performs, by using an input image with a first resolution and a ground truth image with a second resolution greater than the first resolution, training of an image restoration model including a sub-model trained to output a text probability map indicating one or more characters associated with the input image, an encoder to extract feature information from the input image, a fusion layer to combine the text probability map and the feature information, and a decoder to generate an output image with the second resolution, that is connected to the fusion layer. The electronic device provides the image restoration model as a portion of a software application to restore an image. The electronic device trains the encoder using feature information generated by a teacher model that is used to train the sub-model based on knowledge distillation.

### TECHNICAL FIELD

The present disclosure relates to an electronic device for restoring a low-resolution image by using an image restoration model trained by using feature information of a high-resolution image and a method thereof.

### BACKGROUND

Technology is being developed to process a photograph and/or a video using artificial intelligence. For example, technology is being developed to classify a subject (e.g., an object including a person, an animal, and/or a vehicle) captured by a photograph and/or a video. For example, technology is being developed to recognize one or more characters (or strings) associated with a photograph and/or a video.

The above-described information may be provided as a related art for the purpose of helping understanding of the present disclosure. No argument or decision is made as to whether any of the above description may be applied as a prior art related to the present disclosure.

### SUMMARY

### Technical Solution

According to an embodiment, a method of an electronic device may be provided. The method may comprise performing, by using an input image with a first resolution and a ground truth image with a second resolution greater than the first resolution, training of an image restoration model including a sub-model trained to output a text probability map indicating one or more characters associated with the input image, an encoder to extract feature information from the input image, a fusion layer to combine the text probability map and the feature information, and a decoder to generate an output image with the second resolution, that is connected to the fusion layer. The method may comprise providing the image restoration model as a portion of a software application to restore an image. The performing may comprise training the encoder using feature information generated by a teacher model that is used to train the sub-model based on knowledge distillation.

According to an embodiment, an electronic device may comprise memory storing instructions, and at least one processor configured to execute the instructions. The instructions, when executed by the at least one processor individually or collectively, may cause the electronic device to perform, by using an input image with a first resolution and a ground truth image with a second resolution greater than the first resolution, training of an image restoration model including a sub-model trained to output a text probability map indicating one or more characters associated with the input image, an encoder to extract feature information from the input image, a fusion layer to combine the text probability map and the feature information, and a decoder to generate an output image with the second resolution, that is connected to the fusion layer. The instructions, when executed by the at least one processor individually or collectively, may cause the electronic device to provide the image restoration model as a portion of a software application to restore an image. The instructions, when executed by the at least one processor individually or collectively, may cause the electronic device to train the encoder using feature information generated by a teacher model that is used to train the sub-model based on knowledge distillation, to perform training of the image restoration model.

According to an embodiment, a non-transitory computer readable storage medium comprising instructions may be provided. The instructions, when executed by at least one processor of an electronic device individually or collectively, may cause the electronic device to receive a request to restore a first image with a first resolution to a second image with a second resolution greater than the first resolution. The instructions, when executed by the at least one processor of the electronic device individually or collectively, may cause the electronic device to, based on the received request, execute an image restoration model including an encoder to extract feature information from the first image, a sub-model to determine a text probability map with respect to the first image, a fusion layer to combine the text probability map and the feature information, and a decoder to generate the second image with the second resolution, the decoder is connected to the fusion layer. The instructions, when executed by the at least one processor of the electronic device individually or collectively, may cause the electronic device to provide, as a response to the request, the second image with the second resolution, which is obtained based on execution of the image restoration model. The encoder may be trained by using feature information generated by a teacher model, which is used to train the sub-model using knowledge distillation.

According to an embodiment, an electronic device may comprise memory storing instructions, and at least one processor configured to execute the instructions. The instructions, when executed by the at least one processor individually or collectively, may cause the electronic device to receive a request to restore a first image with a first resolution to a second image with a second resolution greater than the first resolution. The instructions, when executed by the at least one processor individually or collectively, may cause the electronic device to, based on the received request, execute an image restoration model including an encoder to extract feature information from the first image, a sub-model to determine a text probability map with respect to the first image, a fusion layer to combine the text probability map and the feature information, and a decoder to generate the second image with the second resolution, the decoder is connected to the fusion layer. The instructions, when executed by the at least one processor individually or collectively, may cause the electronic device to provide, as a response to the request, the second image with the second resolution, which is obtained based on execution of the image restoration model. The encoder may be trained by using feature information generated by a teacher model, which is used to train the sub-model using knowledge distillation.

### BRIEF DESCRIPTION OF DRAWINGS

FIG. 1 illustrates an exemplary block diagram of an electronic device to restore at least a portion of an image.

FIG. 2 illustrates an exemplary block diagram of an image restoration model executed by an electronic device and a teacher model used to train at least a portion of the image restoration model according to an embodiment.

FIG. 3 illustrates an exemplary block diagram of a combination of a teacher model and an image restoration model.

FIG. 4 illustrates an exemplary block diagram of a combination of a teacher model and an image restoration model.

FIG. 5 illustrates an exemplary block diagram of an image restoration model connected to a teacher model.

FIG. 6 illustrates images for describing hidden states of an image restoration model executed by an electronic device according to an embodiment.

FIGS. 7A and 7B illustrate at least one number plate (or license plate), which is a subject included in an image restored by an image restoration model according to an embodiment.

### DETAILED DESCRIPTIONS OF EXEMPLARY EMBODIMENTS

Hereinafter, various embodiments of the present document will be described with reference to the accompanying drawings.

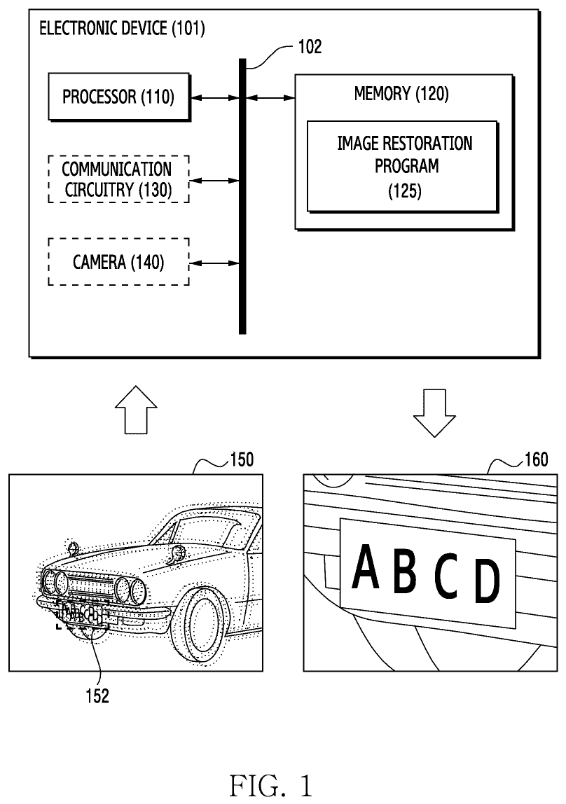

FIG. 1 illustrates an exemplary block diagram of an electronic device 101 to restore at least a portion of an image 150. The electronic device 101 may be configured to at least partially restore or enhance the image 150. Restoring or enhancing the image 150 may include an operation of improving visibility of a subject represented by the image 150 by compensating for distortion included in the image 150, such as blur, afterimage, and optical flow.

Referring to FIG. 1, the image 150 including a portion 152 associated with a license plate (or a number plate) is exemplarily illustrated. For example, the image 150 may be transmitted from an external electronic device to the electronic device 101 through communication circuitry 130. For example, the image 150 may be obtained using a camera 140 included in the electronic device 101. For example, the image 150 may be a file with a format based on a joint photographic experts group (jpeg). For example, the image 150 may include raw data obtained from the camera 140. For example, the image 150 may be included in a sequence (e.g., a video) of image frames, which is included in a video and set to be displayed sequentially. A means for obtaining or receiving the image 150 is not limited to the communication circuitry 130 and/or the camera 140 illustrated in FIG. 1.

Referring to the exemplary image 150 of FIG. 1, an exemplary subject such as a vehicle may be captured. The image 150 may be distorted according to an environment in which a subject is photographed. For example, in case that the subject is moving (e.g., driving of a vehicle), and/or a camera (e.g., the camera 140) controlled to obtain the image 150 is moving (or shaking), an appearance of the subject represented by pixels of the image 150 may be distorted. According to an embodiment, the electronic device 101 may enable the appearance of the subject represented by the image 150 to be clear, by at least partially reducing or removing the distortion generated in the image 150.

Referring to FIG. 1, an exemplary hardware configuration of the electronic device 101 to at least partially restore the image 150 is illustrated. For example, the electronic devices 101 may include a personal computer such as a laptop and a desktop, a smartphone, a smart pad, and a tablet PC. For example, the electronic device 101 may include a smart accessory such as a smartwatch, a smart ring, and/or a head-mounted device (HMD). For example, the electronic device 101 may be referred to as a mobile device, user equipment (UE), a multifunction device, a portable communication device, and/or a portable device. For example, the electronic device 101 may be included as an electronic control unit (ECU) in a vehicle (e.g., an electric vehicle (EV)). For example, the electronic device 101 may include a server of a service provider that provides a service for restoring the image 150. The server may include one or more PCs and/or workstations.

Referring to FIG. 1, according to an embodiment, the electronic device 101 may include at least one of a processor 110, memory 120, the communication circuitry 130, or the camera 140. According to an embodiment, the communication circuitry 130 and/or the camera 140 may not be included in the electronic device 101. For example, the communication circuitry 130 and/or the camera 140 may be disposed outside the electronic device 101 and may be electrically connected to the electronic device 101.

Referring to FIG. 1, the processor 110, the memory 120, the communication circuitry 130, and the camera 140 may be electronically and/or operably coupled with each other by an electronical component such as a communication bus 102. Hereinafter, electronical components being operably combined may mean that a direct connection or an indirect connection between first electronical components and second electronical components is established by wire or wirelessly so that a second electronical component is controlled by a first electronical component. Although illustrated based on different blocks, an embodiment is not limited thereto, and a portion of (e.g., at least a portion of the processor 110, the memory 120, and the communication circuitry 130) the electronical components of FIG. 1 may be included in a single integrated circuit such as a system on a chip (SoC). A type and/or the number of electronical components included in the electronic device 101 is not limited as illustrated in FIG. 1. For example, the electronic device 101 may include only a portion of the electronical components illustrated in FIG. 1.

The processor 110 of the electronic device 101 according to an embodiment may include circuitry (e.g., processing circuitry) for processing data based on one or more instructions. The circuitry for processing data may include, for example, an arithmetic and logic unit (ALU), a floating point unit (FPU), a field programmable gate array (FPGA), a central processing unit (CPU), a graphic processing unit (GPU), a neural processing unit (NPU), and/or an application processor (AP). For example, the number of the processors 110 may be one or more. The processing circuitry of the processor 110 that loads (or fetches) an instruction and performs a calculation corresponding to the loaded instruction may be referred to or referenced as core circuitry (or a core). For example, the processor 110 may have a structure of a multi-core processor including a plurality of core circuitries, such as a dual core, a quad core, a hexa core, or an octa core. A function and/or an operation described with reference to the present disclosure may be individually and/or collectively performed by one or more processing circuitries included in the processor 110.

According to an embodiment, the memory 120 of the electronic device 101 may include circuitry for storing data and/or an instruction inputted and/or outputted to the processor 110. The memory 120 may include, for example, volatile memory such as random-access memory (RAM) and/or non-volatile memory such as read-only memory (ROM). The non-volatile memory may be referred to as storage. The volatile memory may include, for example, at least one of dynamic RAM (DRAM), static RAM (SRAM), cache RAM, and pseudo SRAM (PSRAM). The non-volatile memory may include, for example, at least one of programmable ROM (PROM), erasable PROM (EPROM), electrically erasable PROM (EEPROM), flash memory, a hard disk, a compact disk, a solid state drive (SSD), and an embedded multi media card (eMMC). The memory 120 may include one or more storage mediums (e.g., the volatile memory and/or nonvolatile memory described above) positioned in the electronic device 101 in a distributed manner. The processor 110 of the electronic device 101 may perform a function and/or an operation indicated by instructions, by executing the instructions of the memory 120 in the electronic device 101. For example, in case that the electronic device 101 includes at least one processor, the at least one processor may be configured to execute the instructions collectively or individually.

According to an embodiment, the communication circuitry 130 of the electronic device 101 may include hardware for supporting transmission and/or reception of an electrical signal between the electronic device 101 and the external electronic device (e.g., a user terminal configured to transmit the image 150). The communication circuitry 130 may include at least one of, for example, a modem, an antenna, and an optic/electronic (O/E) converter. The communication circuitry 130 may support transmission and/or reception of an electrical signal based on various types of protocols, such as Ethernet, a local area network (LAN), a wide area network (WAN), wireless fidelity (WiFi), near field communication (NFC), Bluetooth, bluetooth low energy (BLE), ZigBee, long term evolution (LTE), fifth generation (5G), a new radio (NR), sixth generation (6G), and/or above-6G.

According to an embodiment, the camera 140 of the electronic device 101 may include one or more optical sensors (e.g., a charged coupled device (CCD) sensor and a complementary metal oxide semiconductor (CMOS) sensor) that generate an electrical signal indicating a color and/or brightness of light. The plurality of optical sensors included in the camera 140 may be disposed in a form of a 2 dimensional array. The camera 140 may generate 2 dimensional frame data corresponding to light reaching the optical sensors of the 2 dimensional array, by obtaining an electrical signal of each of the plurality of optical sensors substantially simultaneously. For example, photo data captured using the camera 140 may mean a 2 dimensional frame data obtained from the camera 140. For example, video data captured using the camera 140 may mean a sequence of a plurality of 2 dimensional frame data obtained from the camera 140.

Referring to FIG. 1, the processor 110 of the electronic device 101 according to an embodiment may at least partially restore or enhance the image 150 by executing an image restoration program 125. The processor 110 (e.g., the CPU, the GPU, and/or the NPU) executing the image restoration program 125 may perform calculations for restoring the image 150. The calculations may be associated with a computational model (e.g., an artificial neural network, and/or a neural network) configured to simulate a neural activity of a living organism. The neural activity may include, for example, a cognitive activity, an inference activity, and/or a creative activity of a living organism. For example, instructions indicating the computational model, formulas associated with the computational model, and/or a constant (e.g., coefficients and/or weights) included in the formulas, may be at least partially included in the image restoration program 125.

According to an embodiment, the processor 110 of the electronic device 101 may restore or enhance the portion 152 (e.g., a portion of an object in which one or more characters are printed is captured, such as a number plate and/or a sign plate) in which at least one character is captured, in the image 150. For example, in the image 150, the electronic device 101 may extract or segment (or crop) the portion 152 associated with at least one character. The portion 152 may be referred to as a region of interest (ROI). The processor 110 may restore or enhance the portion 152 by executing the image restoration program 125.

In an embodiment, the electronic device 101 may increase or enhance a resolution of a scene by recognizing text (e.g., text that is indicated as being captured or included in the scene) associated with the scene such as the image 150. For example, in case of detecting one or more characters from a scene of a relatively low resolution (or small size), the electronic device 101 may generate another scene corresponding to the scene and having a higher resolution (or a larger size) than the resolution of the scene, by using a shape and/or an appearance of the detected one or more characters. For example, with respect to a scaling factor f, from a scene with a width w and a height h, the electronic device 101 may generate or output a scene with a width fw and a height fh.

In an embodiment, in terms of recognizing text and generating a high-resolution scene, the image restoration program 125 and/or artificial intelligence driven by the image restoration program 125 may be referred to as a scene text image super-resolution (STISR) and/or a model for the STISR. A performance of the STISR may be evaluated using accuracy (e.g., STISR accuracy) of a character included in the high-resolution scene generated by executing the STISR.

Referring to FIG. 1, an image 160 that the electronic device 101 outputs as a result of restoring the portion 152 of the image 150 is illustrated. The image 150 and/or the portion 152 may be referred to as an input image in terms of being inputted to the processor 110 of the electronic device 101. The image 160 may be referred to as an output image in terms of output data corresponding to the input image. According to an embodiment, the electronic device 101 may obtain information indicating one or more characters associated with the portion 152 by using an artificial intelligence model trained to recognize one or more characters from an image. By using the information, the electronic device 101 may generate or output the image 160 as a high-resolution image corresponding to the portion 152.

Referring to FIG. 1, the image 160 may have a larger size than the portion 152 and/or a higher resolution than the portion 152. Dimensions (e.g., a width and/or a height) of the image 160 may be greater than dimensions of the portion 152. For example, the image 160 may have the same dimensions and/or resolution as the image 150. In an embodiment of receiving the image 150 and/or the portion 152 from the external electronic device through the communication circuitry 130, the electronic device 101 may receive a request for restoring the portion 152 of the image 150 with a first resolution to the image 160 with a second resolution greater than the first resolution. From a signal received from the external electronic device, the electronic device 101 may identify or detect the image 150 and/or the portion 152. The signal may include a command and/or an operand indicating the request for restoration of the portion 152. In an embodiment of receiving the entire image 150 including the portion 152, the processor 110 of the electronic device 101 may extract or segment the portion 152 in which a subject relation to one or more characters is captured, such as a number plate. The portion 152 may be used as an image used for restoration.

Based on the request for restoring the image 150 and/or the portion 152, the electronic device 101 may execute an artificial intelligence model (e.g., an image restoration model) provided by the image restoration program 125. The electronic device 101 may provide the image 160 of the second resolution, obtained based on the execution of the image restoration model, as a response to the request. For example, the electronic device 101 may transmit a signal including the image 160 to the external electronic device through the communication circuitry 130.

In an embodiment, the image restoration model executed by the image restoration program 125 may include a sub-model trained to recognize one or more characters (e.g., indicated to be captured by an input image) associated with the input image (e.g., the portion 152 and/or the image 150 including the portion 152) inputted to the image restoration model. The sub-model, which is information (e.g., explicit information) readable by the processor 110 executing a software application distinct from the image restoration model and/or the image restoration program 125, may be trained to output information indicating the one or more characters associated with the input image, degrees to which each of the one or more characters is associated with the input image (e.g., probabilities that one or more characters are captured by the input image), and/or a positional relationship of the one or more characters (e.g., a position and/or an order of each of the one or more characters in a string).

For example, the information outputted from the sub-model may be referred to as text probability information in terms of including probabilities indicating text indicated to be captured by the input image. The text probability information may be referred to as text categorical information, text probability, a text probability map, text prior information, and/or text distribution. For example, the text probability information may include category information of text and/or information indicating a visual cue for text in an image.

In an embodiment, the sub-model, which is included in the image restoration model and outputs the text probability information, may be pre-trained by a teacher model. The teacher model may be executed using parameters more than parameters set by the sub-model. The teacher model may be designed to process higher-dimensional information (e.g., the input image) than the sub-model, or to perform more calculations than the sub-model. When the sub-model of the image restoration model is trained using knowledge distillation, a combination of the input image and ground truth data (e.g., ground truth text probability information) may be generated based on execution of the teacher model, and the combination may be used to train the sub-model.

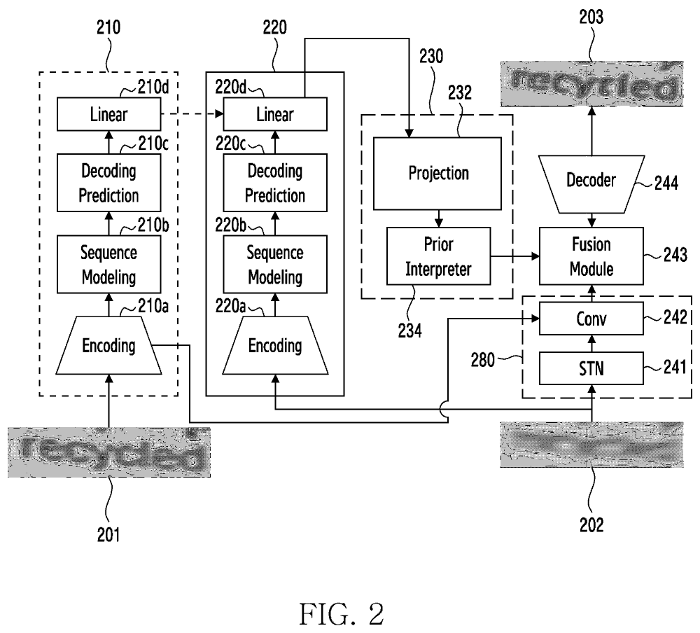

In an embodiment, the image restoration model executed by the processor 110 may include the sub-model trained to generate the text probability information, and may include another sub-model trained by information (e.g., output data of the teacher model and/or hidden states of an intermediate layer of the teacher model) of the teacher model used for training the sub-model. The other sub-model may be configured to compute nontextual feature information (e.g., structural feature information and/or logits information) of the input image by being disposed in a different portion from the sub-model that extracts the text probability information from the input image (e.g., the portion 152 and/or the image 150). For example, using the other sub-model, the processor 110 may infer or determine feature information to restore the high-resolution image 160 from a low-resolution image (e.g., the portion 152) in which structural feature information is distorted or deteriorated. An exemplary structure of the image restoration model including the other sub-model will be described with reference to FIGS. 2 to 5.

Hereinafter, an exemplary structure of the image restoration model executed by the image restoration program 125 and a process of training the image restoration model will be exemplarily described with reference to FIGS. 2 to 5.

FIG. 2 illustrates an exemplary block diagram of a structure of an image restoration model executed by an electronic device (e.g., the electronic device 101 of FIG. 1) according to an embodiment. The electronic device 101 and/or the processor 110 of FIG. 1 may execute the image restoration model described with reference to FIG. 2 by executing an image restoration program 125.

Hereinafter, an operation of executing an artificial intelligence model, such as the image restoration model, may include operations of performing one or more calculations associated with the artificial intelligence model by using a processor device (e.g., the processor 110 of FIG. 1 including the GPU and/or the NPU) of the electronic device. The operation of executing the artificial intelligence model may include an operation of inputting commands (or instructions) indicating the calculations to the GPU and/or the NPU to perform the calculations by the GPU and/or the NPU. The operation of executing the artificial intelligence model may include an operation of inputting data (e.g., the input image such as the image 150 and/or the portion 152 of FIG. 1) to be at least partially changed by the calculations to the GPU and/or the NPU. Although the operation of executing the artificial intelligence model based on the GPU and/or the NPU has been exemplarily described, an embodiment is not limited thereto, and an operation of executing the artificial intelligence model using a CPU may also be performed similarly to the above-described operation.

Referring to FIG. 2, calculations performed by the image restoration model are illustrated as a plurality of blocks for distinguishing types and/or an order of the calculations. Any one block of FIG. 2 may correspond to a group of calculations performed while executing the artificial intelligence model (e.g., the image restoration model). Each of the blocks of FIG. 2 may be referred to as a computation, layer(s), a sub-model and/or a module for the artificial intelligence model. Referring to FIG. 2, the image restoration model including a teacher model 210 connected to the image restoration model is exemplarily illustrated to train at least a portion of the image restoration model.

For example, the image restoration model may include an encoder 280 (e.g., a combination of a spatial transformer networks (STN) computation 241 and a convolution computation 242) for extracting feature information from an image. The encoder 280 including the STN calculation 241 and/or the convolution calculation 242 may include a shallow convolutional neural network (CNN) that has a small loss of structural information (or spatial information) required for restoring the image. The shallow CNN may include fewer layers than a backbone network (e.g., ResNet including 50 or more convolutional layers) with a structure in which a large number of layers are connected in a chain for feature extraction. The backbone network may be trained to perform a high-level vision task, such as a classification task, that calculates a class vector from a high-resolution image. The encoder (or a STISR) of the image restoration model may include a relatively small number of layers to reduce the loss of the structural information (or the spatial information) of a low-resolution image when extracting a feature of the low-resolution image to perform a low-level vision task (e.g., a task of increasing a resolution of an image). By executing the encoder 280 of the image restoration model, the electronic device may generate or obtain feature information on an input image 202. The feature information may include summarized (or reduced dimensional) information of the input image 202 to specify or distinguish the input image 202. The feature information may include positions and/or characteristics of one or more pixels uniquely included in the input image 202, such as a feature point (or a key point) and/or a boundary line.

For example, the image restoration model may include a sub-model 220 for determining a text probability map with respect to the input image 202. The teacher model 210 may generate training information (e.g., ground truth data and input data corresponding to the ground truth data) used to train the sub-model 220 using knowledge distillation. The number of calculations of the sub-model 220 and parameters (e.g., coefficients and/or weights) used in the calculations, may be less than the number of calculations of the teacher model 210 and parameters used in the calculations of the teacher model 210. For example, the sub-model 220 may be pre-trained by the teacher model 210 executed using the parameters more than the parameters for the sub-model 220.

In an embodiment, the teacher model 210 used for training the sub-model 220 may be trained to recognize one or more characters from a scene such as an image 201. The sub-model 220 may be referred to as a student model in terms of being trained by the teacher model 210. In terms of character recognition, the teacher model 210 may be referred to as a scene-text recognizer (STR) and/or a STR model. The teacher model 210 may be configured to recognize or process a feature such as a shape and/or a position of the one or more characters in the image 201.

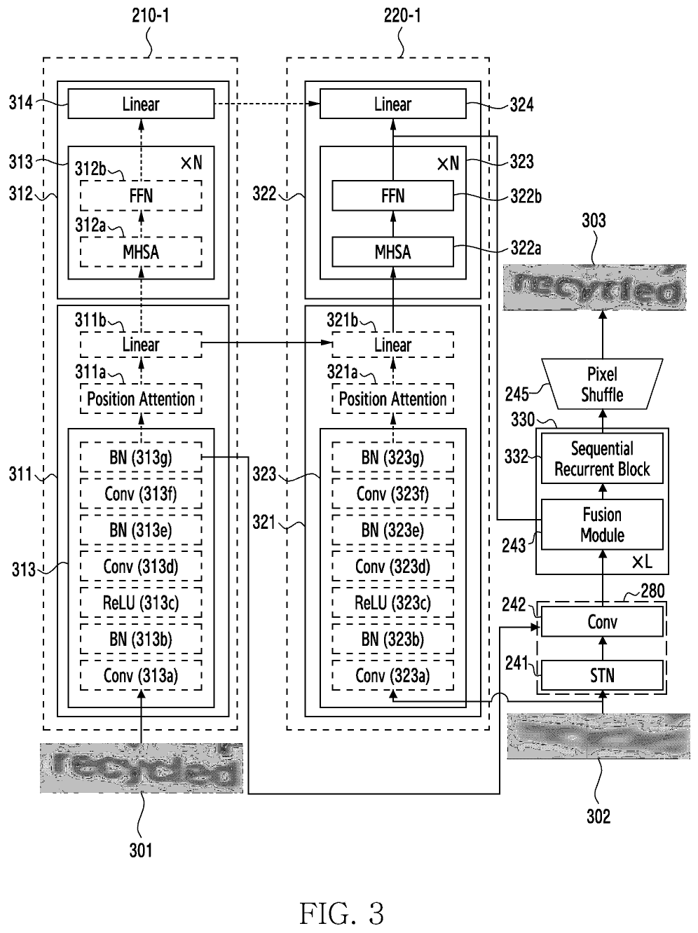

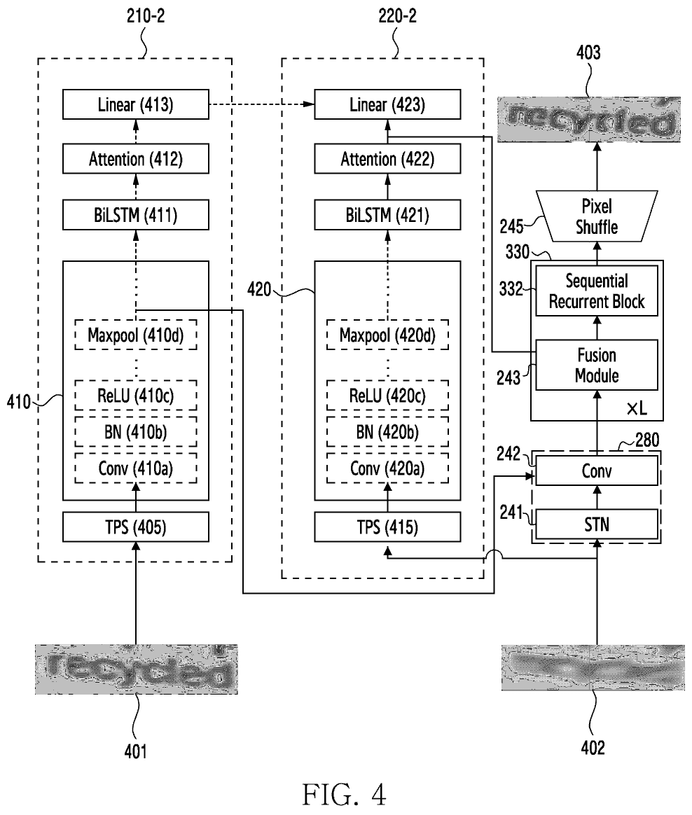

Referring to FIG. 2, types and orders of calculations of the teacher model 210 and the sub model 220 may be similar or identical to each other. For example, when executing the sub-model 220, the electronic device may obtain or generate output data (e.g., text probability information and/or the text probability map) by sequentially performing an encoding computation 220a, a sequence modeling computation 220b, a decoding prediction computation 220c, and a linearization computation 220d on the input image 202. The computations (e.g., the encoding computation 220a, the sequence modeling computation 220b, the decoding prediction computation 220c, and the linearization computation 220d) sequentially performed in the sub-model 220 may correspond to computations (e.g., an encoding computation 210a, a sequence modeling computation 210b, a decoding prediction computation 210c, and a linearization computation 210d) sequentially performed in the teacher model 210, respectively. A connection of the computations described above may have a structure of thin plate spline transformation (TPS)-Residual neural Network (ResNet)-bidirectional long-short term memory (BiLSTM)-attention (TRBA). An exemplary structure of the sub-model 220 having a structure of the TRBA will be described in detail with reference to FIG. 4. An embodiment is not limited to thereto, and another structure (or a topology) such as a convolution-recurrent neural network (CRNN), an autonomous, bidirectional and iterative network (ABINet), and/or a permuted autoregressive sequence (PARseq) may be applied to the structure of the sub-model 220. In an embodiment, an exemplary structure of the sub-model 220 having a structure of the ABINet is described in detail with reference to FIG. 3. An output layer of the sub-model 220 may include values determined by calculations performed for a linearization computation. The values included in the output layer may be the text probability information.

According to an embodiment, the electronic device may train the sub-model 220 using the teacher model 210 to which the image 201 having a relatively high resolution is inputted. For example, the electronic device executing the teacher model 210 may determine, from the image 201, the text probability map indicating one or more characters associated with the image 201. The electronic device may train the sub-model 220 using another image having a lower resolution than the image 201 and the determined text probability map. The image 201 may have a higher resolution than the input image 202 to be inputted to the image restoration model, and/or may have a larger size than the input image 202.

Referring to FIG. 2, the output layer of the sub-model 220 may be configured to perform the linearization computation. Information (e.g., the text probability information) outputted from the output layer of the sub-model 220 may be provided to a synthesis module 243. Before being provided to the synthesis module 243, internal information may be inputted to a projection model 230. Using the projection model 230, the electronic device may sequentially perform a projection computation 232 and a prior interpreter computation 234 on the text probability information. The text probability information that is at least partially changed by the projection model 230 may be inputted to the synthesis module 243. A combination of the sub-model 220 and the projection model 230 may be referred to as a STR of the image restoration model. Information (e.g., information transmitted from the projection model 230 to the synthesis module 243) outputted by the projection model 230 and inputted to the synthesis module 243 may be referred to as prior knowledge information.

The combination of the sub-model 220 and the projection model 230 may cause the electronic device executing the image restoration model to generate the output image 203 using textual information (e.g., the text probability information) inferred from the input image 202. The encoder 280, which is a combination of the spatial transformer networks (STN) computation 241 and the convolution computation 242, may cause the electronic device executing the image restoration model to generate the output image 203 using nontextual information (e.g., the structural information) inferred from the input image 202. In terms of both the textual information and the nontextual information being used, the image restoration model may be a model supporting multimodality.

Referring to FIG. 2, the image restoration model executed by the electronic device according to an embodiment may include the sub-model 220 trained to output the text probability map indicating the one or more characters associated with the input image 202, the encoder 280 (e.g., the combination of the spatial transformer networks (STN) computation 241 and the convolution computation 242) for extracting the feature information from the input image 202, the synthesis module 243 for combining the text probability map and the feature information, and the decoder 244 connected to the synthesis module 243 to generate the output image 203 of a second resolution greater than a first resolution of the input image 202. The decoder 244 may be trained to generate the output image 203 (e.g., including content of the input image 202) that has a greater resolution than the input image 202 and/or a wider size than the input image 202 and associated with the input image 202 from information generated by the synthesis module 243. The output image 203 may be provided as a result of restoring or enhancing the input image 202.

Referring to FIG. 2, the electronic device may train or tune a computation (the spatial transformer networks (STN) computation 241 and/or the convolution computation 242) associated with the encoder 280, by using the teacher model 210 configured to train the sub-model 220 using the knowledge distillation. For example, when training the image restoration model, the electronic device may perform training of the encoder using feature information (e.g., feature information of the image 201 such as structural information and/or logits information of the image 201) generated by the teacher model 210, which is used to train the sub-model 220 based on the knowledge distillation. For example, the electronic device may perform knowledge distillation training on the encoder 220a based on the feature information of the image 201 having a relatively high resolution.

For example, the encoder 210a of the teacher model 210 which is the STR and/or feature information generated from the encoder 210a may be used for training the shallow CNN of the image restoration model, which is the STISR. For example, the feature information may be directly transferred or provided to the shallow CNN. Since it is trained by the feature information of the encoder 210a of the teacher model 210, the electronic device executing the encoder 220a of the image restoration model may obtain or generate feature information, such as that extracted from a high-resolution image from the low-resolution input image 202. In terms of the teacher model 210 used for the knowledge distillation being used for training another portion of the image restoration model excluding the sub-model 220, the image restoration model of FIG. 2 may be referred to as a unified distillation framework (UDF).

In an embodiment, the image restoration model may be trained to output the output image 203 from the input image 202 by a training process of a first step of training the sub-model 220 using the knowledge distillation associated with the teacher model 210 and a second step of training the entire image restoration model including the sub-model 220. In the second step, the encoder of the image restoration model may be trained based on the feature information generated by the teacher model 210 and/or a hidden state of the teacher model 210 (or an intermediate state and/or feature information of an intermediate layer of the teacher model 210).

Hereinafter, an exemplary structure of the image restoration model including the sub-model 220 having the structure of the ABINet will be described with reference to FIG. 3.

FIG. 3 illustrates an exemplary block diagram of a combination of a teacher model 210-1 and an image restoration model. The electronic device 101 and/or processor 110 of FIG. 1 may perform calculations indicated by the trained image restoration model with reference to FIG. 3, by executing the image restoration program 125.

Referring to FIG. 3, the image restoration model including a sub-model 220-1 having a structure of an ABINet and a teacher model 210-1 connected to the image restoration model are illustrated. Blocks of FIG. 3 may be distinguished according to a computation defined for simulation of artificial intelligence. The teacher model 210-1 having the structure of the ABINet may include a vision model 311 trained to extract a visual feature from an image 301 and a language model 312 trained to recognize one or more characters associated with the image 301 from the visual feature. The vision model 311 of the teacher model 210-1 may include a backbone model 313. The sub-model 220-1 may also include a vision model 321 corresponding to the vision model 311 of the teacher model 210-1 and a language model 322 corresponding to the language model 312 of the teacher model 210-1. The vision model 321 of the sub-model 220-1 may include a backbone model 323. Each of the vision model 321, the language model 322, and the backbone model 323 of the sub-model 220-1 may be reduced (e.g., a size, a dimension, and/or a depth of layers) models of the vision model 311, the language model 312, and the backbone model 313 of the teacher model 210-1.

Referring to FIG. 3, each of the backbone models 313 and 323 of the teacher model 210-1 and/or the sub-model 220-1 may include a chain combination of a first convolution computation 313a or 323a, a first batch normalized (BN) computation 313b or 323b, a rectified linear unit (ReLU) computation 313c or 323c, a second convolution computation 313d or 323d, a second BN computation 313e or 323e, a third convolution computation 313f or 323f, and a third BN computation 313g or 323g with respect to an input image (e.g., the image 301 and/or an input image 302). A result of performing the third BN computation 313g or 323g may be processed by a chain combination of a position attention computation 311a or 321a and a linearization computation 311b or 321b of a vision model (e.g., the vision models 311 and 321 of the teacher model 210-1 and/or the sub-model 220-1). A language model (e.g., the language models 312 and 322 of the teacher model 210-1 and/or the sub-model 220-1) connected to the vision model may include a repetitive computation 313 or 323 (e.g., N times) of a chain combination of a multi-head self-attention (MHSA) computation 312a or 322a and a feed-forward network (FFN) computation 312b or 322b and a linearization computation 314 or 324 for a results of the repetitive computation 313 or 323.

For example, feature information E_{p,HR} such as Equation 1 may be calculated from an encoder (e.g., a backbone model 313) of the teacher model 210-1.

$$\begin{matrix}{E}_{p , H R} = E n {c}_{t e a , H R} ( T P {S}_{t e a} ( {x}_{H R} ) ) , & early layer output {E}_{p , HR}^{early} ∈ {ℝ}^{h \times w \times c}\end{matrix} \qquad [ Equation 1 ]$$

x_{HR} of Equation 1 may indicate the image 301 having a relatively high resolution. TPSₜₑₐ of Equation 1 may indicate a TPS computation of the teacher model 210-1. From feature information E_{p,HR} of Equation 1, by using a decoder (e.g., the language model 312) of the teacher model 210-1, the electronic device may generate logits information on text of Equation 2.

$${t}_{H R} = D e {c}_{t e a} ( {E}_{p , H R} ) \cdot {W}_{p} \qquad [ Equation 2 ]$$

Similar to Equation 1, from an encoder (e.g., the backbone model 323) of the sub-model 220-1, the electronic device may obtain feature information E_{p,LR} on the input image 302, as in Equation 3.

$${E}_{p , L R} = E n {c}_{s t u , L R} ( T P {S}_{s t u} ( {x}_{L R} ) ) \qquad [ Equation 3 ]$$

Similar to Equation 2, from a decoder (e.g., the language model 322) of the sub-model 220-1, the electronic device may obtain logits information t_{LR} on text, such as Equation 4.

$${t}_{LR} = {Dec}_{stu} ( {E}_{p , LR} ) \qquad [ Equation 4 ]$$

Feature information E_{p,LR} of Equation 4 may correspond to the feature information E_{p,LR} of Equation 3. From logits information t_{LR} of Equation 4, the electronic device may obtain or calculate feature information Fₚ, as in Equation 5.

$${F}_{p} = ( {t}_{LR} + PE ) \cdot {W}_{p} \qquad [ Equation 5 ]$$

The PE of Equation 5 may indicate position embedding. Based on a linearization computation, the electronic device may obtain feature information F′ₚ of Equation 6 from the feature information Fₚ of Equation 5.

$${F}_{p}^{′} = LN ( softmax ( \frac{{Q}_{p} {K}_{p}^{T}}{\sqrt{d}} ) {V}_{p} + {F}_{p} \qquad [ Equation 6 ]$$

The electronic device may obtain feature information F″ₚ of Equation 7 from the feature information F′ₚ of Equation 6. The feature information F″ₚ of Equation 7 may indicate a result of performing the linearization computation 324.

$${F}_{p}^{″} = LN ( {F}_{p}^{′} \cdot {W}_{p}^{′} + {F}_{p}^{′} ) \qquad [ Equation 7 ]$$

Wₚ′ of Equation 7 may indicate a weight matrix of a feedforward layer (e.g., a feedforward layer of the language model 322). Referring to FIG. 3, from the teacher model 210-1 configured to receive the image 301 having a resolution higher than the input image 302, feature information to be provided to the sub-model 220-1 and/or an encoder of the image restoration model (e.g., a convolution computation 242) may be generated. For example, a result of performing the third BN computation 313g of the backbone model 313 may be used for training the convolution computation 242 of an encoder 280. In the example, the result of performing the third BN computation 313g may be used to calculate or determine a loss function [symbol] _{CT}_{ₕₜₗ} for training the convolution computation 242. For example, a result of the linearization computation 311b of the vision model 311 of the teacher model 210-1 may be used for training the vision model 321 of the sub-model 220-1. In the example, the result of the linearization computation 311b of the vision model 311 may be used to calculate or determine a loss function [symbol] _{CD}_{ᵥᵢₛ} for training the vision model 321. For example, a result of the linearization computation 314 of the language model 312 of the teacher model 210-1 may be used for training the language model 322 of the sub-model 220-1 and/or the sub-model 220-1. In the example, the result of the linearization computation 314 of the language model 312 of the teacher model 210-1 may be used to calculate or determine a loss function [symbol] _{CD}_{_{lang}} for training the sub-model 220-1 and/or the language model 322.

In an embodiment, using the teacher model 210-1, at least a portion (e.g., the convolution computation 242) of the encoder 280 as well as the sub-model 220-1 of the image restoration model may be trained. Since the encoder 280 is at least partially trained, the encoder may be trained to output information similar to the encoder 280 (e.g., the backbone model 313) of the teacher model 210-1 with respect to the same input image. For example, in case that the input image 302 is inputted to the encoder 280 of the image restoration model, a result of the convolution computation 242 may be identical to or similar to a result of a computation of the backbone model 321 with respect to the input image 302.

In case that the input image 302 is inputted to the image restoration model, the input image 302 may be processed by the sub-model 220-1. Using the sub-model 220-1, the electronic device may obtain a text probability map. Simultaneously with being processed by the sub-model 220-1, the input image 302 may be processed by the encoder of the image restoration model. The result of the convolution computation 242 of the encoder 280 may be combined with the text probability map in a synthesis module 243 (or a synthesis layer). Calculations indicated by a combination 330 of the synthesis module 243 and a sequential-recurrent block (SRB) 332 may be repeatedly performed L times. As a result of repeatedly performing the calculations of the combination 330 is processed by a pixel shuffle model 245, an output image 303 having a resolution greater than a resolution of the input image 302 and/or a size greater than a size of the input image 302 may be generated.

Hereinafter, an operation of training the image restoration model including the sub-model having a structure of TRBA will be described with reference to FIG. 4.

FIG. 4 illustrates an exemplary block diagram of a combination of a teacher model 210-2 and an image restoration model 220-2. The electronic device 101 and/or processor 110 of FIG. 1 may perform calculations indicated by the trained image restoration model with reference to FIG. 4, by executing an image restoration program 125.

Referring to FIG. 4, an image restoration model including the sub-model 220-2 having a structure of TRBA and a structure of the teacher model 210-2 connected to the image restoration model are illustrated. Blocks of FIG. 4 may be distinguished according to a computation defined for simulation of artificial intelligence. Based on the structure of the TRBA, the teacher model 210-2 may include a chain connection of a TPS model 405, a backbone model 410, BILSTM 411, an attention model 412, and a linearization model 413. Similarly, the sub-model 220-2 may include a chain connection of a TPS model 415, a backbone model 420, BILSTM 421, an attention model 422, and a linearization model 423. A backbone model (e.g., the backbone models 410 and 420 of the teacher model 210-2 and the sub-model 220-2) may have a structure similar to the backbone model (e.g., the backbone models 313 and 323) of FIG. 3. The backbone model of FIG. 4 may include a backbone model such as a ResNet. For example, the backbone models 410 or 420 may include a chain combination of a convolution computation 410a or 420a, a BN computation 410b or 420b, a ReLU computation 410c or 420c, and a Maxpool computation 410d or 420d.

Together with the sub-model 220-2, the image restoration model may include independent layers for processing an input image 402. For example, the image restoration model may include the layers starting from an encoder 280 including a STN computation 241 and a convolution computation 242. Feature information generated from the encoder 280 may be combined with text probability information of the sub-model 220-2 in a synthesis module 243 (or a synthesis layer). Calculations corresponding to a combination 330 of the synthesis module 243 and a SRB 332 may be repeatedly performed a preset number of times (e.g., L times). As a result of repeatedly performing the calculations of the combination 330 is processed by a pixel shuffle model 245, an output image 403 having a resolution greater than a resolution of the input image 402 and/or a size greater than a size of the input image 402 may be generated.

For example, the input image 402 (x_{LR}∈ [symbol] ^{h×w×3}) may be processed independently or substantially simultaneously in each of layers including the STN 241 and layers of the sub-model 220-2 of the image restoration model. From the encoder 280 of the image restoration model, the electronic device may obtain low-level feature information. The electronic device may obtain feature information Fᵥ∈ [symbol] ^{c×hw} to be inputted to the synthesis module 243, by combining position embedding information associated with the synthesis module 243 with the feature information. [symbol] is a mathematical symbol indicating a set of real numbers, and C of [symbol] ^{c×hw} is the number indicating a dimension of feature information, and may correspond to the number of dimensions of information (e.g., three channels each of red, green, and blue configuring RGB) outputted from an output layer of the encoder 280. hw of [symbol] ^{c×hw} may indicate a size (e.g., the number of parameters arranged in 1 dimension) of information (e.g., 1 dimensional information) that flattens information of the input image 402. Before obtaining the low-level feature information, the electronic device may cause uniformly forms of one or more characters included in the input image 402 by performing a TPS computation such as Equation 8.

$${F}_{v} = Flatten ( {F}_{v}^{low} + PE ) \qquad [ Equation 8 ]$$

$$such that {F}_{v}^{low} = {Enc}_{1} ( TPS ( {x}_{LR} ) )$$

PE of Equation 8 may indicate position embedding information. Flatten of Equation 8 may indicate a computation of converting multidimensional information into 1 dimensional information. Enc1 of Equation 8 may indicate a computation performed at the encoder 280. The image restoration model according to an embodiment may consider adjacency between pixels in an image by using the position embedding information as an index indicating importance between the pixels in the image. Therefore, according to an embodiment, the image restoration model may be trained to use information (e.g., the PE, which is the position embedding information of Equation 5) indicating a spatial characteristic of the image, to consider a distance between the pixels in the image while calculating feature information.

x_{LR} of Equation 8 may correspond to the input image 402. Fᵥ of Equation 8 may indicate a result of performing a flatten computation with respect to a result Fᵥ^{low}+PE of combining feature information Fᵥ^{low} and position encoding PE obtained using the encoder 280.

Meanwhile, with respect to the input image 402, the electronic device that performs calculations indicated by the sub-model 220-2, which is a Scene Text Recognizer (STR), may generate feature information having a size of [symbol] for the number [symbol] of classes (e.g., classes corresponding to each of a plurality of characters) distinguishable by the sub-model 220-2. The feature information having the size (or a dimension) of the [symbol] may be changed into feature information having a size of the [symbol] ^{|×C} by layer normalization and a feedforward computation. 1 may indicate the number of RNN decoding computations to be performed by the sub-model 220-2 for the attention computation 422. In the synthesis module 243, the feature information having the size of the [symbol] ^{|×C} and the feature information having the size of the R^{c×hw} may be synthesized.

When the image restoration model is synthesized, the electronic device may obtain, or generate, feature information E_{p,HR}^{early} of an early layer from the teacher model 210-2 connected to the sub-model 220-2. Referring to FIG. 4, an embodiment of obtaining the feature information E_{p,HR}^{early} to be directly transmitted to the convolution computation 242 in the backbone model 410 is illustrated, but the embodiment is not limited thereto. In an encoder (e.g., the backbone model 410) of the teacher model 210-2, dimension reduction with respect to an image 401 inputted to the teacher model 210-2 may be performed. The electronic device may obtain or extract the feature information E_{p,HR}^{early} early of a dimension identical to a dimension of an encoder (e.g., the backbone model 420 of the sub-model 220-2), which is a shallow CNN including the convolution computation 242, among gradually reduced dimensions in an encoder (e.g., the backbone model 410 of the teacher model 210-2). An embodiment is not limited thereto, and by performing interpolation, the electronic device may obtain the feature information E_{p,HR}^{early} that may be transmitted to the encoder 280 of the image restoration model. Hereinafter, each of t_{HR} and t_{LR} may indicate logits information for each of high-resolution logits transfer and low-resolution logits transfer from the teacher model 210-2 to the sub-model 220-2.

According to an embodiment, the electronic device may calculate or determine, from layers of the teacher model 210-2, loss functions to be used for training the image restoration model including the sub-model 220-2. For example, from the backbone model 410 of the teacher model 210-2, the electronic device may generate or determine a loss function [symbol] _{CT}_{ₕₜₗ} to be used for training the convolution computation 242. From an output layer (e.g., a layer configured to perform a linearization computation) of the teacher model 210-2, the electronic device may generate or determine a loss function [symbol] _{CD}_{ᵥᵢₛ} to be used for training the sub-model 220-2. Using the loss function [symbol] _{CT}_{ₕₜₗ}, the electronic device may perform training of the encoder 280 so that the encoder 280 of the image restoration model including the convolution computation 242 operates similarly to the backbone model 410.

Referring to FIG. 4, in the synthesis module 243, multi-head cross-attention may be performed on feature information Fᵥ∈ [symbol] ^{c×hw} obtained from the encoder 280 and feature information F″ₚ∈ [symbol] ^{|×c} obtained from the sub-model 220-2. As a result of performing the multi-head cross-attention, Fₚ″′ may be performed based on Equation 9.

$${F}_{p}^{′′′} = LN ( \frac{{Q}_{v} {K}_{p}^{′ ′ T}}{\sqrt{d}} ) {V}_{p}^{″} ) \qquad [ Equation 9 ]$$

A query for performing the multi-head cross-attention of Equation 9 may correspond to a vector having a size of feature information [symbol] ^{c×hw} obtained by the convolution computation 242 (e.g., Fᵥ·W_{q}_{₂}∈ [symbol] ^{c×hw}). W_{q}_{₂} may indicate a weight matrix applied for the feedforward computation. A key and a value for performing the multi-head cross-attention of Equation 9 may correspond to a vector having a size (or a dimension) of [symbol] ^{|×C} (e.g., Fₚ″·Wₖ₂∈ [symbol] ^{|×c}). Herein, Wₖ₂ may indicate a weight matrix applied for the feedforward computation. Q·K^{T} of Equation 9 may be [symbol] _{hw×l}, and QᵥKₚ″^{T} of Equation 9 may be [symbol] ^{hw×c}. Referring to Equation 9, feature information Fₚ′″ obtained using a softmax computation and a layer normalization (LN) computation may be obtained from the synthesis module 243 that performs the multi-head cross-attention.

With respect to the result F′″ₚ of Equation 9, the electronic device may calculate or obtain feature information F to be inputted to a decoder (e.g., the decoder 244 of FIG. 2) of the image restoration model by performing calculations based on a feedforward network and layer normalization, as in Equation 10. Between the feedforward network and the layer normalization, a residual connection for an element-wise sum may be formed.

$$F = LN ( {F}_{p}^{′′′} \cdot {W}_{f} + {F}_{p}^{′′′} ) \qquad [ Equation 10 ]$$

F′″ₚ of Equation 10 may indicate final feature information (e.g., the feature information F′″ₚ of Equation 9) based on prior knowledge. An addition computation of Equation 10 may be defined by the residual connection. W_{f} of Equation 10 may indicate a matrix applied by the feedforward computation. The layer normalization LN may be performed to compensate for the addition computation performed by the residual connection. Referring to FIG. 4, the SRB 332 may be designed so that BILSTM for the convolution computation and sequence modeling is repeated L times (e.g., 5 times). Feature information (e.g., an image having a relatively small size) outputted from the SRB 332 may be enlarged into an output image 403 having a resolution greater than the input image 402 and/or a size larger than the input image 402 by the pixel shuffle model 245. For example, a restored image, which is the output image 403, may be indicated as in Equation 11.

$$Restored Image = PixelSuffle ( SRB ( {F}_{v} , F ) ) \qquad [ Equation 11 ]$$

Fᵥ of Equation 11 may correspond to Fᵥ of Equation 8 (e.g., feature information of the input image 402). Fᵥ of Equation 11 may be feature information obtained using the prior knowledge of Equation 10. SRB of Equation 11 may indicate a sequential recurrent computation defined by the SRB 332 of FIG. 4. Finally, the output image 403 may be generated based on a Pixelshuffle computation.

When training the image restoration model having a structure of FIG. 4, a loss function used for training the image restoration model may indicate a difference between a ground truth image corresponding to the input image 402 and the output image 403. For example, a L1 distance (e.g., a Manhattan distance and/or a Mean absolute error) between the ground truth image and the output image 403, may be determined as the loss function. An embodiment is not limited thereto, and a L2 distance (or mean squared loss), a structural similarity index (SSIM), a triplex SSIM (TSSIM), and a Kullback-Leibler (KL) Divergence loss function for knowledge distillation may be used. For example, a loss function [symbol] ₛ based on the L2 distance may be defined as in Equation 12.

$${ℒ}_{s} = {\vert {I}_{SR} - {I}_{HR} \vert}_{2} \qquad [ Equation 12 ]$$

I_{SR} of Equation 12 may indicate the output image 403, and I_{HR} may indicate the ground truth image. That is, the loss function [symbol] ₛ may be defined as a mean squared error (MSE) (or the L2 distance) between the output image 403 and the ground truth image. For example, a loss function based on the TSSIM may be used, such as a loss function [symbol] ₜₛₛᵢₘ of Equation 13.

$${ℒ}_{tssim} = 1 - TSSIM \qquad [ Equation 13 ]$$

$$such that TSSIM = \frac{( {μ}_{x} {μ}_{y} + {μ}_{y} {μ}_{z} + {μ}_{x} {μ}_{z} + {C}_{1} ) ( {σ}_{xy} + {σ}_{yz} + {σ}_{xz} + {C}_{2} )}{( {μ}_{x}^{2} + {μ}_{y}^{2} + {μ}_{z}^{2} + {C}_{1} ) ( {σ}_{x}^{2} + {σ}_{x}^{2} + {σ}_{x}^{2} + {C}_{2} )}$$

x of Equation 13 may correspond to the deteriorated output image 403, y may correspond to the output image 403, and z may correspond to the ground truth image. Each of μ and σ of Equation 13 is a mean and standard deviation of corresponding an image (e.g., x, y, or z). C of Equation 13 may be an epsilon value (e.g., a preset number set to prevent a zero division error, preferably C¹=0.01², C²=0.03²).

To compensate for a domain gap between the high-resolution image 401 used by the teacher model 210-2 and the low-resolution input image 402 used by the image restoration model (or the sub-model 220-2), the electronic device may use a loss function [symbol] _{cd} as in Equation 14.

$${ℒ}_{cd} = {\vert {t}_{HR} - {t}_{LR} \vert}_{1} + {D}_{KL} ( {t}_{LR} ‖ {t}_{HR} ) \qquad [ Equation 14 ]$$

Each of t_{HR} and t_{LR} of Equation 14 may indicate a probability distribution (e.g., a probability distribution of the prior knowledge) obtained by inputting a high-resolution image and a low-resolution image into the STR (e.g., the teacher model 210-2 and/or the sub-model 220-2). t_{HR} of Equation 14 may be generated from the frozen teacher model 210-2. A freeze of a model may mean a state in which parameters of the model are fixed so as not to be changed for training. t_{LR} of Equation 14 may be generated from the trainable sub-model 220-2. DKL of Equation 14, which is a kullback leibler divergence, may indicate a difference in distributions of t_{HR} and t_{LR}. Using the loss function [symbol] _{cd} including the DKL, the sub-model 220-2 may be trained to output a low-resolution image that reduces the difference in the distributions of t_{HR} and t_{LR}.

According to an embodiment, the electronic device may use a loss function [symbol] _{ct} of Equation 15 when training the encoder 280 by performing the knowledge distillation on the teacher model 210-2. The loss function [symbol] _{ct} may be used to transmit text focused feature information (or text oriented information) of a STR model (e.g., the teacher model 210-2) to a STISR model (e.g., the image restoration model).

$${ℒ}_{ct} = {\vert {E}_{p , HR}^{early} - {F}_{v}^{low} \vert}_{2} \qquad [ Equation 15 ]$$

Referring to FIG. 4, the electronic device may obtain or generate feature information focused on a text area (or a character area) of the input image 402 using the convolution computation 242 (or the encoder 280) trained by the loss function [symbol] _{ct} associated with the backbone model 410 of the teacher model 210-2.

According to an embodiment, the electronic device may perform training on the sub-model 220-2 by using a cross-entropy loss on the ground truth data. The cross-entropy loss may be set as a loss function [symbol] ₛₜᵣ of Equation 16.

$${ℒ}_{str} = CE ( {t}_{LR} , {y}_{gt} ) \qquad [ Equation 16 ]$$

y_{gt} of Equation 16 may indicate a correct answer label (e.g., ground truth data) for an image received as an input. In an exemplary embodiment of FIG. 4, y_{gt} may be “recycled”. After training on the sub-model 220-2 using a loss function [symbol] ₛₜᵣ of Equation 16, the frozen sub-model 220-2 may be obtained. The electronic device may obtain an image restoration model focused on a portion associated with one or more characters in the input image 402 by using a loss function to reduce an attention score of the high-resolution image 401 and the output image 403 and/or a loss function to reduce a difference in a probability distribution of the high-resolution image 401 and the output image 403, by using the frozen sub model 220-2.

$${ℒ}_{txt} = α \cdot {‖ {A}_{HR} - {A}_{SR} ‖}_{1} + β \cdot WCE ( {p}_{pred} , {y}_{gt} ) \qquad [ Equation 17 ]$$

∥A_{HR}−A_{SR}∥₁ of Equation 17 may mean the L1 distance. Each of A_{HR} and A_{SR} of Equation 17 may be attention information (or an attention map) for a high-resolution image and attention information (or an attention map) for the output image 403 (e.g., an image restored by the image restoration model), obtained from an additional artificial intelligence model (e.g., a text recognition network) for processing the output image 403. p_{pred} of Equation 17 may indicate text logits information obtained by inputting the output image 403 to the text recognition network. y_{gt} of Equation 17 may indicate the ground truth data, A loss function [symbol] ₜₓₜ of Equation 17 may be defined to reduce a difference between the attention information A_{SR} for the output image 403 and the attention information A_{HR} for the high-resolution image. The loss function [symbol] ₜₓₜ of Equation 17 may be used to reduce an error between the attention map and the text logits information, obtained from the additional artificial intelligence model (e.g., the text recognition network) for processing the output image 403. According to an embodiment, the electronic device may perform joint learning with respect to a combination of the above-described loss functions, as in Equation 18 below. A combination [symbol] ₜₒₜₐₗ of the loss functions may be set as in Equation 18.

$${ℒ}_{total} = {λ}_{1} {ℒ}_{s} + {λ}_{2} {ℒ}_{tssim} + {λ}_{3} {ℒ}_{cd} + {λ}_{4} {ℒ}_{ct} + {λ}_{5} {ℒ}_{str} + {λ}_{6} {ℒ}_{txt} \qquad [ Equation 18 ]$$

It may be set to numerical values such as λ₁=1, λ₂=1, λ₃=1, λ₄=0.001, λ₅=0.01, λ₆=0.5 of Equation 18. An embodiment is not limited thereto. [symbol] ₛ of Equation 18 may be defined as Equation 12. [symbol] ₜₛₛᵢₘ of Equation 18 may be defined as Equation 13. [symbol] _{cd} of Equation 18 may be defined as Equation 14. Act of Equation 18 may be defined as Equation 15. [symbol] ₜₓₜ of Equation 18 may be defined as Equation 17.

Referring to FIG. 4, the electronic device may obtain or generate the output image 403 from the input image 402 by executing the image restoration model including the convolution computation 242 trained using feature information of the backbone model 410. The image restoration model may be provided as a portion of a software application (e.g., the image restoration program 125 of FIG. 1) for restoring an image.

In an embodiment of FIG. 4, information used for the knowledge distillation may be associated with Table 1 to Table 2.

TABLE 1

| Domain-to-domain | Source | Target |
|---|---|---|
| Image domain | High-resolution image | Low-resolution image |
| Task | High-level vision | High-level vision |
| Distilled Knowledge | Logits information of | Logits information of sub- |
| | teacher model 210-2 | model 220-2 |

TABLE 2

| Task-to-task | Source | Target |
|---|---|---|
| Image domain | High-resolution image | Low-resolution image |
| Task | High-level vision | Low-level vision |
| Distilled Knowledge | Feature information of | Shallow feature of |
| | backbone model 410 | convolution computation |
| | | 242 |

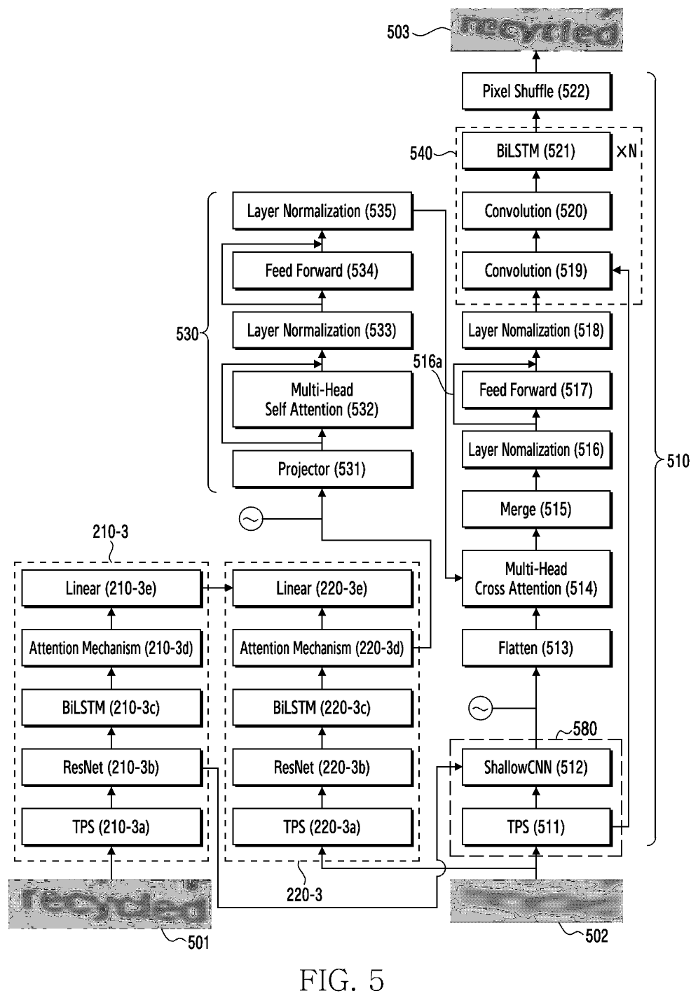

Hereinafter, a detailed structure of the image restoration model described with reference to FIGS. 1 to 4 will be exemplarily described with reference to FIG. 5.

FIG. 5 illustrates an exemplary block diagram of an image restoration model connected to a teacher model 210. The electronic device 101 and/or the processor 110 of FIG. 1 may obtain, generate, and/or train an image restoration model described with reference to FIG. 5, by executing an image restoration program 125.

Referring to FIG. 5, the image restoration model may include a TPS model 511 and a shallow CNN 512. A combination of the TPS model 511 and the shallow CNN 512 may be referred to as an encoder 580 of the image restoration model. The electronic device may extract low-level feature information, by performing calculations indicated by the encoder 580, from an input image 502. The electronic device may obtain shapes of characters having a relatively uniform shape, by performing calculations indicated by a Flatten model 513, with respect to the feature information.

In a state of processing the input image 502 using the image restoration model, the electronic device may perform a first operation of processing the input image 502 using the TPS model 511 and/or the shallow CNN 512 and a second operation of processing the input image 502 using a sub-model 220-3 in parallel (or substantially simultaneously). The first operation and the second operation may be performed substantially simultaneously by different processors included in the electronic device. From the sub-model 220-3, the electronic device may obtain or generate text probability information that explicitly indicates one or more characters associated with the input image 502. The text probability information may be referred to as explicit information (or explicit feature information).

The electronic device may process the text probability information outputted from the sub-model 220-3 using a projection model 530. In the projection model 530, a projector 531, a multi-head self-attention model 532, a first layer normalization model 533, a feed forward model 534, and a second layer normalization model 535, may be combined in a chain. Using the projection model 530, the electronic device may generate or obtain other feature information to be combined with feature information generated by execution of the encoder 580.

According to an embodiment, the electronic device may perform multi-head cross-attention between feature information Fᵥ∈ [symbol] ^{c×hw} of the shallow CNN 512 and feature information F∈ [symbol] ^{|×C} outputted from the projection model 530 in a multi-head cross-attention model 514 of the image restoration model. F′″ₚ of Equation 9 may correspond to a result of performing the multi-head cross-attention.

With respect to feature information obtained from the multi-head cross-attention model 514, the electronic device may perform calculations indicated by a chain connection of a merge model 515, a first layer normalization model 516, a feed forward model 517, and a second layer normalization model 518. Referring to FIG. 5, a residual connection 516a for an element-wise sum may be formed between the first layer normalization model 516 and the second layer normalization model 518. The residual connection 516a may be formed between the first layer normalization model 516 and the second layer normalization model 518 independently of the feed forward model 517.

Referring to FIG. 5, with respect to information obtained from the second layer normalization model 518, the electronic device may repeatedly perform calculations based on a BiLSTM model 521 N times (e.g., 5 times). A combination of a first convolution model 519, a second convolution model 520, and the BILSTM model 521, connected to the second layer normalization model 518, may be referred to as a decoder 540. The feature information F of Equation 10 may correspond to feature information obtained from the decoder 540.

In an embodiment, the electronic device may increase a resolution and/or a size of an image (e.g., an image indicated by the feature information F of Equation 10) outputted by the decoder 540 by using a pixel shuffle model 522. For example, an output image 503 outputted from the pixel shuffle model 522 of the image restoration model may be indicated as Equation 11.

To train the image restoration model described above, a teacher model 210-3 associated with the sub-model 220-3 may be used. The teacher model 210-3 exemplified in FIG. 5 may include a chain connection between a TPS model 210-3a for a TPS computation, a backbone model 210-3b based on a ResNet, BILSTM 210-3c, an attention model 210-3d, and a linearization model 210-3c. Similarly, the sub-model 220-2 may include a chain connection of a TPS model 220-3a, a backbone model 220-3b, BILSTM 220-3b, an attention model 220-3d, and a linearization model 220-3c. The teacher model 210-3 may be trained to generate text categorical information (e.g., a text probability map) from an image 501 having a resolution greater than the input image 502 and/or a size greater than the input image 502. The electronic device may determine a loss function (e.g., the loss function [symbol] ₛₜᵣ of Equation 16) for knowledge distillation for the sub-model 220-3 using the teacher model 210-3. The loss function may be calculated using the text categorical information obtained from an output layer of the teacher model 210-3.

For example, the electronic device may further determine a loss function (e.g., the loss function [symbol] _{ct} of Equation 15) for training the shallow CNN 512 using a state (e.g., state information and/or a hidden state vector) of an intermediate layer (or a hidden layer) of the teacher model 210-3. The loss function may be calculated using feature information (or the state information of the intermediate layer) calculated from the intermediate layer (or an intermediate layer of a backbone model referred to as a ResNet) of the teacher model 210-3 having the same dimension as the shallow CNN 512. The shallow CNN 512 trained by the loss function may be trained to generate unbiased feature information with respect to the input image 502 with a relatively small resolution. For example, the shallow CNN 512 may be trained to generate low-dimensional feature information that may be inferred from the high-resolution image 501 with respect to the low-resolution input image 502.

As described above, according to an embodiment, the electronic device may execute the image restoration model including the sub-model 220-3 and the projection model 530, which may be executed at least temporarily simultaneously with models 510 for restoring the input image 502. The models 510 may be combined with the pre-trained sub-model 220-3 for recognizing a character. Using the sub-model 220-3, the electronic device may effectively obtain prior knowledge (or prior information) to be used to restore or enhance the input image 502. The image restoration model may restore or enhance the input image 502 using explicit information (e.g., one or more characters associated with the input image 502 and a relative position of the one or more characters) outputted from the sub-model 220-3. Since the input image 502 is restored by using information associated with text, the electronic device may be trained to interpret a number plate and/or a sign plate.

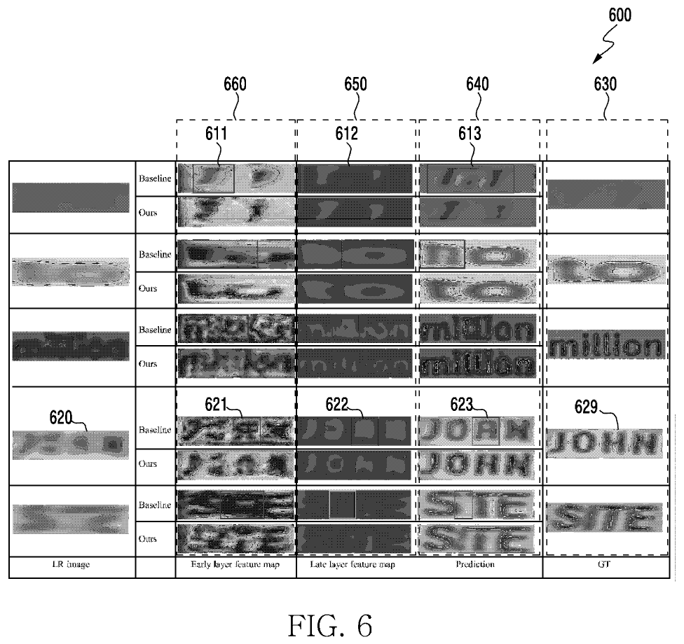

Hereinafter, feature information propagated in layers of the image restoration model described with reference to FIGS. 1 to 5 will be exemplarily described with reference to FIG. 6.

FIG. 6 illustrates images for describing hidden states of an image restoration model executed by an electronic device according to an embodiment. Referring to FIG. 6, according to an embodiment, a table 600 including images represented by information of a hidden layer and an output layer in an image restoration model (“Ours”), and images represented by information of a hidden layer and an output layer of a general image restoration model (“Baseline”), is illustrated.

Ten high-resolution images (e.g., images illustrated in a “prediction” column 640 of the table 600) obtained by restoring each of five low-resolution images (e.g., the portion 152 of FIG. 1 and/or the input image 202 of FIG. 2) by executing the image restoration model and the general image restoration model according to an embodiment respectively, and five ground truth images (e.g., images illustrated in a “GT” column 630 of the table 600) corresponding to each of the five low-resolution images are illustrated. For example, a low-resolution image 620 may be paired with a ground truth image 629.

In the table 600 of FIG. 6, feature maps of hidden layers of a model (e.g., the image restoration model and the general image restoration model according to an embodiment) used to restore or enhance a low-resolution image may be visualized. For example, along an “early layer feature map” column 660 of the table 600, a feature map of a first hidden layer positioned relatively close to an input layer among the hidden layers of the model may be visualized. For example, along a “late layer feature map” column 650 of the table 600, a feature map of a second hidden layer (e.g., a hidden layer positioned after the first hidden layer) positioned relatively close to an output layer among the hidden layers of the model may be visualized. For example, in the table 600, a change in a feature map propagated in the model may be visualized along the “early layer feature map” column 660, the “late layer feature map” column 650, and the “prediction” column 640.

Referring to FIG. 6, when information indicating a low-resolution image is propagated in the general image restoration model, an error occurring in a specific layer may be gradually spread or enlarged in a feature map. For example, in the general image restoration model, the error may be included in a portion 611 of feature information of the first hidden layer. The error may cause distortion of a portion 612 having a size larger than the portion 611 in feature information of the second hidden layer. Finally, in an output image outputted from an output layer of the general image restoration model, the portion 612 having a size larger than the portions 611 and 612 may be distorted.

Similarly, in case that the general image restoration model is executed in response to a request to restore the low-resolution image 620, an error may occur in a portion 621 of the feature information of the first hidden layer of the general image restoration model. In case that the feature information propagates along layers of the general image restoration model, the error may be maintained or increased, such as a portion 622, in the feature information of the second hidden layer in the general image restoration model after the first hidden layer. Finally, the output image of the general image restoration model may represent a character (e.g., “A”) that is different from a character (e.g., “H” in “JOHN”) represented by the ground truth image 629 by the error, such as a portion 623.

According to an embodiment, the image restoration model executed by the electronic device may be trained to prevent propagation of an error in the general image restoration model. For example, the electronic device may estimate structural information in which the image restoration model is weakened due to a resolution of the image 620 from the low-resolution image 620 by using a teacher model (e.g., the teacher model 210 of FIG. 2). By using the structural information, the electronic device may reduce or prevent an error included in feature information propagating in the image restoration model. Referring to the table 600 of FIG. 6, an output image obtained from the low-resolution image 620 using the image restoration model may include characters identical to characters (e.g., “JOHN”) represented by the ground truth image 629.

When comparing the general image model with the image restoration model according to an embodiment, as in Table 3, the image restoration model according to an embodiment has a relatively high performance index (or an accuracy index).

TABLE 3

| Encoder | ACC | PSNR | SSIM |
|---|---|---|---|
| x | 0.451 | 21.38 | 0.768 |
| 0.01 | 0.452 | 21.31 | 0.769 |
| 0.001 | 0.461 | 21.43 | 0.773 |

Table 3 is a set of performance indices measured using a public data set, such as textzoom, and in all performance indices including STISR accuracy, a peak signal-to-noise ratio (PSNR), and a SSIM, a performance of the image restoration model according to an embodiment was measured to be higher than another image restoration model.

As described above, the electronic device according to an embodiment may execute the image restoration model configured to generate information (e.g., a text probability map) associated with text from an input image. The image restoration model may include the sub-model previously trained to generate the information from the input image. When the image restoration model is trained, an encoder for extracting low-level feature information from the input image may be trained using the teacher model used to train the sub-model. By executing the image restoration model including the trained encoder, the electronic device may restore or enhance the input image. Since the electronic device uses the image restoration model trained to recognize the information (e.g., the text probability map) associated with a character from the input image, the electronic device may clearly restore a number plate and/or a sign plate included in the input image or captured by the input image.

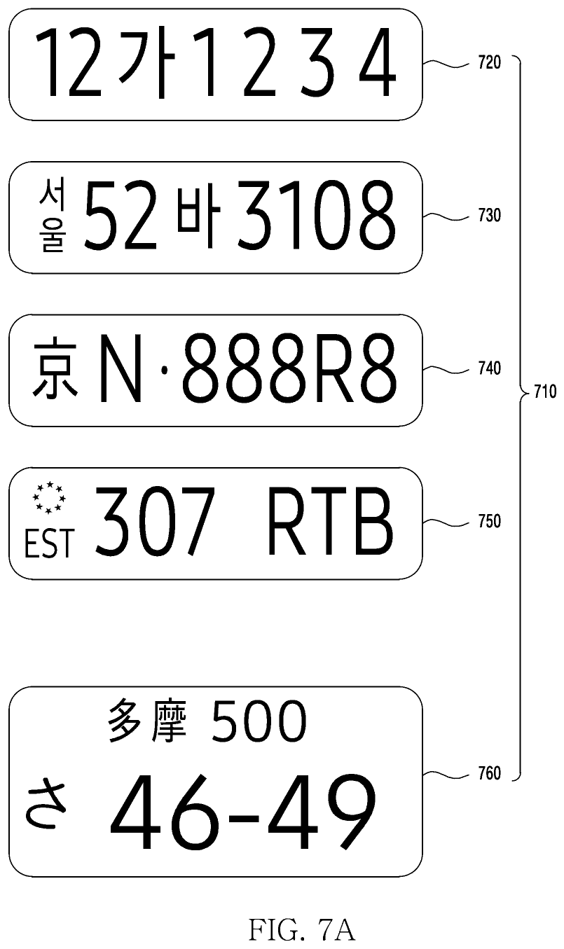

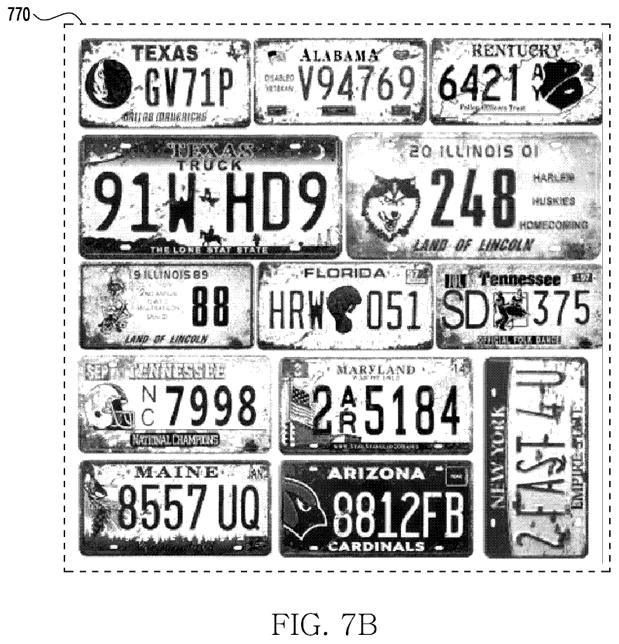

Hereinafter, number plates restored by the image restoration model are exemplarily illustrated with reference to FIGS. 7A to 7B.

FIGS. 7A and 7B illustrate at least one number plate (or license plate), which is a subject included in an image restored by an image restoration model according to an embodiment.

Referring to FIG. 7A, images 710 including at least one number plate obtained from the image restoration model are illustrated. The images 710 may be outputted from, or provided by, an electronic device that executes the image restoration model as a result of restoring or enhancing a low-resolution input image (e.g., the input image 202 of FIG. 2).

For example, the electronic device may generate an image 720 including a number plate based on the law of the Republic of Korea. The image 720 may include numbers (e.g., 12), indicating a type of a vehicle, an alphabet (e.g., “ [symbol] ”) indicating a purpose of the vehicle, and numbers (e.g., 1234) indicating a serial number uniquely assigned to the vehicle. For example, the electronic device may obtain an image 730 including a number plate based on the law of the Republic of Korea. The image 730 may further include, with respect to the image 720, characters (e.g., a place name such as “Seoul”) indicating an area associated with the number plate. A background color of the number plate represented through the images 720 and 730 may indicate a category (e.g., a private vehicle) of the vehicle defined by the law of the Republic of Korea.

For example, the electronic device may generate an image 740 including a number plate based on the law of China. In the image 740, a character (e.g., [symbol] ) indicating an area associated with the number plate and a character (e.g., N) indicating a city (e.g., a sub-area of the area) associated with the number plate may include information on the area or use. The image 740 may include serial numbers (e.g., 788R8) uniquely assigned to a vehicle. A color of the number plate represented through the image 740 may indicate a category (e.g., a passenger car, a large vehicle, a bus, a truck, and/or a motorcycle) of the vehicle.

For example, the electronic device may generate an image 750 including a number plate based on the law of the European Union. The image 750 may include a symbol indicating the European Union, characters (e.g., EST) indicating an area associated with the number plate, and serial numbers (e.g., “307 RTB”) uniquely assigned to a vehicle on which the number plate is mounted. An embodiment is not limited thereto, and the image 750 may further include a flag of a country in which the number plate is mounted as a country affiliated with the European Union.

For example, the electronic device may generate an image 760 including a number plate based on the law of Japan. The image 760 may include characters (e.g., [symbol] ) indicating an area, numbers (e.g., 500) indicating a category of a vehicle, a character indicating a purpose of a business associated with the vehicle, and serial numbers (e.g., 46-49) uniquely assigned to the vehicle on which the number plate is mounted.

Referring to FIG. 7B, images 770 including a number plate based on the law of the United States generated by the electronic device according to an embodiment are illustrated. Referring to the images 770, based on the law of the United States, the number plate including an image and/or a figure defined by a state government of the United States may be generated. The number plate may include text (e.g., “TEXAS”, “ALABAMA”, “KENTUCKY”, and the like) indicating a state government together with an image and/or a figure indicating the state government in which a vehicle is registered. Together with the text, the image representing the number plate may include a serial number (e.g., a combination of alphabets and/or the numbers such as “GV71P”) uniquely assigned to the vehicle.

In an embodiment, a method of training an image restoration model using feature information of a teacher model may be required. In an embodiment, a method of training another portion of the image restoration model different from a sub-model corresponding to the teacher model may be required using the feature information generated by the teacher model that processes a high-resolution image. As described above, according to an embodiment, a method of an electronic device may be provided. The method may comprise performing, by using an input image with a first resolution and a ground truth image with a second resolution greater than the first resolution, training of an image restoration model including a sub-model trained to output a text probability map indicating one or more characters associated with the input image, an encoder to extract feature information from the input image, a fusion layer to combine the text probability map and the feature information, and a decoder to generate an output image with the second resolution, that is connected to the fusion layer. The method may comprise providing the image restoration model as a portion of a software application to restore an image. The performing may comprise training the encoder using feature information generated by a teacher model that is used to train the sub-model based on knowledge distillation. According to an embodiment, the electronic device may perform training of the image restoration model using the feature information of the teacher model. According to an embodiment, the electronic device may train another portion of the image restoration model different from the sub-model corresponding to the teacher model using the feature information generated by the teacher model that processes the high-resolution image.

For example, the feature information generated by the teacher model may be obtained from, among intermediate layers included in the teacher model, an intermediate layer configured to generate feature information having a size identical to a size of the feature information of the encoder.

For example, the sub-model may be trained to output the text probability map indicating one or more characters indicated as captured by the input image and positions of the one or more characters.

For example, the method may comprise performing, using the teacher model executed using parameters more than parameters for the sub-model, training of the sub-model to be used to train the image restoration model.

For example, the providing may comprise executing, in response to a request to restore a portion associated with a license plate segmented from a source image, the image restoration model.

As described above, according to an embodiment, an electronic device may comprise memory storing instructions, and at least one processor configured to execute the instructions. The instructions, when executed by the at least one processor individually or collectively, may cause the electronic device to perform, by using an input image with a first resolution and a ground truth image with a second resolution greater than the first resolution, training of an image restoration model including a sub-model trained to output a text probability map indicating one or more characters associated with the input image, an encoder to extract feature information from the input image, a fusion layer to combine the text probability map and the feature information, and a decoder to generate an output image with the second resolution, that is connected to the fusion layer. The instructions, when executed by the at least one processor individually or collectively, may cause the electronic device to provide the image restoration model as a portion of a software application to restore an image. The instructions, when executed by the at least one processor individually or collectively, may cause the electronic device to train the encoder using feature information generated by a teacher model that is used to train the sub-model based on knowledge distillation, to perform training of the image restoration model.

For example, the feature information generated by the teacher model, in the image restoration model, may be obtained from, among intermediate layers included in the teacher model, an intermediate layer configured to generate feature information having a size identical to a size of the feature information of the encoder.

For example, the sub-model may be trained to output the text probability map indicating one or more characters indicated as captured by the input image and positions of the one or more characters.

For example, the instructions, when executed by the at least one processor individually or collectively, may cause the electronic device to perform, using the teacher model executed using parameters more than parameters for the sub-model, training of the sub-model.

For example, the instructions, when executed by the at least one processor individually or collectively, may cause the electronic device to execute, in response to a request to restore a portion associated with a license plate segmented from a source image, the image restoration model.

As described above, according to an embodiment, a non-transitory computer readable storage medium comprising instructions may be provided. The instructions, when executed by at least one processor of an electronic device individually or collectively, may cause the electronic device to receive a request to restore a first image with a first resolution to a second image with a second resolution greater than the first resolution. The instructions, when executed by the at least one processor of the electronic device individually or collectively, may cause the electronic device to, based on the received request, execute an image restoration model including an encoder to extract feature information from the first image, a sub-model to determine a text probability map with respect to the first image, a fusion layer to combine the text probability map and the feature information, and a decoder to generate the second image with the second resolution, the decoder is connected to the fusion layer. The instructions, when executed by the at least one processor of the electronic device individually or collectively, may cause the electronic device to provide, as a response to the request, the second image with the second resolution, which is obtained based on execution of the image restoration model. The encoder may be trained by using feature information generated by a teacher model, which is used to train the sub-model using knowledge distillation.

For example, the feature information generated by the teacher model may be obtained from, among intermediate layers included in the teacher model, an intermediate layer configured to generate feature information having a size identical to a size of the feature information of the encoder.

For example, the sub-model may be trained to output the text probability map indicating one or more characters indicated as captured by the first image and positions of the one or more characters.

For example, the sub-model may be pre-trained by the teacher model that is executed using parameters more than parameters for the sub-model.

For example, the instructions, when executed by the at least one processor of the electronic device individually or collectively, may cause the electronic device to receive, from an external electronic device through communication circuitry of the electronic device, a first signal including the request and a third image. The instructions, when executed by the at least one processor of the electronic device individually or collectively, may cause the electronic device to, based on receiving the first signal, segment, in the third image, a portion associated with a license plate as the first image. The instructions, when executed by the at least one processor of the electronic device individually or collectively, may cause the electronic device to transmit, based on obtaining the second image from the restoration model executed using the segmented first image, a second signal including the second image to the external electronic device.

As described above, according to an embodiment, an electronic device may comprise memory storing instructions, and at least one processor configured to execute the instructions. The instructions, when executed by the at least one processor individually or collectively, may cause the electronic device to receive a request to restore a first image with a first resolution to a second image with a second resolution greater than the first resolution. The instructions, when executed by the at least one processor individually or collectively, may cause the electronic device to, based on the received request, execute an image restoration model including an encoder to extract feature information from the first image, a sub-model to determine a text probability map with respect to the first image, a fusion layer to combine the text probability map and the feature information, and a decoder to generate the second image with the second resolution, the decoder is connected to the fusion layer. The instructions, when executed by the at least one processor individually or collectively, may cause the electronic device to provide, as a response to the request, the second image with the second resolution, which is obtained based on execution of the image restoration model. The encoder may be trained by using feature information generated by a teacher model, which is used to train the sub-model using knowledge distillation.

For example, the feature information generated by the teacher model may be obtained from, among intermediate layers included in the teacher model, an intermediate layer configured to generate feature information having a size identical to a size of the feature information of the encoder.

For example, the sub-model may be trained to output the text probability map indicating one or more characters indicated as captured by the first image and positions of the one or more characters.

For example, the sub-model may be pre-trained by the teacher model that is executed using parameters more than parameters for the sub-model.

For example, the instructions, when executed by the at least one processor individually or collectively, may cause the electronic device to receive, from an external electronic device through communication circuitry of the electronic device, a first signal including the request and a third image. The instructions, when executed by the at least one processor individually or collectively, may cause the electronic device to, based on receiving the first signal, segment, in the third image, a portion associated with a license plate as the first image. The instructions, when executed by the at least one processor individually or collectively, may cause the electronic device to transmit, based on obtaining the second image from the restoration model executed using the segmented first image, a second signal including the second image to the external electronic device.

The device described above may be implemented as a hardware component, a software component, and/or a combination of a hardware component and a software component. For example, the devices and components described in the embodiments may be implemented by using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to the embodiment may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include a magnetic medium such as a hard disk, floppy disk, and magnetic tape, optical recording medium such as a CD-ROM and DVD, magneto-optical medium, such as a floptical disk, and those configured to store program instructions, including ROM, RAM, flash memory, and the like. In addition, examples of other media may include recording media or storage media managed by app stores that distribute applications, sites that supply or distribute various software, servers, and the like.

As described above, although the embodiments have been described with limited examples and drawings, a person who has ordinary knowledge in the relevant technical field is capable of various modifications and transform from the above description. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

Therefore, other implementations, other embodiments, and those equivalent to the scope of the claims are in the scope of the claims described later.

1. A method of an electronic device, comprising:
performing, by using an input image with a first resolution and a ground truth image with a second resolution greater than the first resolution, training of an image restoration model including:
a sub-model trained to output a text probability map indicating one or more characters associated with the input image;
an encoder to extract feature information from the input image;
a fusion layer to combine the text probability map and the feature information; and
a decoder to generate an output image with the second resolution, that is connected to the fusion layer; and
providing the image restoration model as a portion of a software application to restore an image;
wherein the performing comprises:
training the encoder using feature information generated by a teacher model that is used to train the sub-model based on knowledge distillation.

2. The method of claim 1, wherein the feature information generated by the teacher model is obtained from, among intermediate layers included in the teacher model, an intermediate layer configured to generate feature information having a size identical to a size of the feature information of the encoder.

3. The method of claim 1, wherein the sub-model is trained to output the text probability map indicating one or more characters indicated as captured by the input image and positions of the one or more characters.

4. The method of claim 1, further comprising:
performing, using the teacher model executed using parameters more than parameters for the sub-model, training of the sub-model to be used to train the image restoration model.

5. The method of claim 1, wherein the providing comprising:
executing, in response to a request to restore a portion associated with a license plate segmented from a source image, the image restoration model.

6. The method of claim 5, wherein the executing further comprising:
executing the image restoration model to restore the portion of the source image using at least one text inferred from the portion.

7. The method of claim 1, wherein the image restoration model is trained to restore the image with multimodality inferring both of textual information and nontextual information from the image.

8. An electronic device comprising:
memory storing instructions; and
at least one processor configured to execute the instructions,
wherein the instructions, when executed by the at least one processor individually or collectively, cause the electronic device to:
perform, by using an input image with a first resolution and a ground truth image with a second resolution greater than the first resolution, training of an image restoration model including:
a sub-model trained to output a text probability map indicating one or more characters associated with the input image;
an encoder to extract feature information from the input image;
a fusion layer to combine the text probability map and the feature information; and
a decoder to generate an output image with the second resolution, that is connected to the fusion layer; and
provide the image restoration model as a portion of a software application to restore an image;
to perform training of the image restoration model:
train the encoder using feature information generated by a teacher model that is used to train the sub-model based on knowledge distillation.

9. The electronic device of claim 8, wherein the feature information generated by the teacher model, in the image restoration model, is obtained from, among intermediate layers included in the teacher model, an intermediate layer configured to generate feature information having a size identical to a size of the feature information of the encoder.

10. The electronic device of claim 8, wherein the sub-model is trained to output the text probability map indicating one or more characters indicated as captured by the input image and positions of the one or more characters.

11. The electronic device of claim 8, wherein the instructions, when executed by the at least one processor individually or collectively, cause the electronic device to:
perform, using the teacher model executed using parameters more than parameters for the sub-model, training of the sub-model.

12. The electronic device of claim 9, wherein the instructions, when executed by the at least one processor individually or collectively, cause the electronic device to:
execute, in response to a request to restore a portion associated with a license plate segmented from a source image, the image restoration model.

13. The electronic device of claim 12, wherein the instructions, when executed by the at least one processor individually or collectively, cause the electronic device to:
execute the image restoration model to restore the portion of the source image using at least one text inferred from the portion.

14. The electronic device of claim 8, wherein the image restoration model is trained to restore the image with multimodality inferring both of textual information and nontextual information from the image.

15. A non-transitory computer readable storage medium comprising instructions, wherein the instructions, when executed by at least one processor of an electronic device individually or collectively, cause the electronic device to:
receive a request to restore a first image with a first resolution to a second image with a second resolution greater than the first resolution,
based on the received request, execute an image restoration model including:
an encoder to extract feature information from the first image;
a sub-model to determine a text probability map with respect to the first image;
a fusion layer to combine the text probability map and the feature information; and
a decoder to generate the second image with the second resolution, the decoder is connected to the fusion layer; and
provide, as a response to the request, the second image with the second resolution, which is obtained based on execution of the image restoration model,
wherein the encoder is trained by using feature information generated by a teacher model, which is used to train the sub-model using knowledge distillation.

16. The non-transitory computer readable storage medium of claim 15, wherein the feature information generated by the teacher model is obtained from, among intermediate layers included in the teacher model, an intermediate layer configured to generate feature information having a size identical to a size of the feature information of the encoder.

17. The non-transitory computer readable storage medium of claim 15, wherein the sub-model is trained to output the text probability map indicating one or more characters indicated as captured by the first image and positions of the one or more characters.

18. The non-transitory computer readable storage medium of claim 17, wherein the sub-model is pre-trained by the teacher model that is executed using parameters more than parameters for the sub-model.

19. The non-transitory computer readable storage medium of claim 15, wherein the instructions, when executed by the least one processor of the electronic device individually or collectively, cause the electronic device to:
execute the image restoration model to restore the first image with the first resolution using at least one text inferred from the first image.

20. The non-transitory computer readable storage medium of claim 15, wherein the image restoration model is trained to restore the image with multimodality inferring both of textual information and nontextual information from the first image.
